(19) United States
(12) Patent Application Publication
(10) Pub. No.: US 2022/0109812 A1
(43) Pub. Date: Apr. 7, 2022

(54) OVERLAY VIDEO DISPLAY FOR VEHICLE

(71) Applicant: Hypergiant Industries, Inc., Austin, TX (US)

(72) Inventors: Benjamin Edward Lamm, Dallas, TX (US); Daniel David Haab, Austin, TX (US)

(21) Appl. No.: 17/494,583

(22) Filed: Oct. 5, 2021

Related U.S. Application Data
(60) Provisional application No. 63/087,609, filed on Oct. 5, 2020.

(51) Int. Cl. H04N 7/18; G06V 20/58; G06V 20/40; H04N 5/247; H04N 5/232; G06T 11/00; G06F 3/01; B60R 1/22

(52) U.S. Cl. CPC H04N 7/181; G06V 20/58; G06V 20/41; H04N 5/247; B60R 2300/20; G06T 11/00; G06F 3/012; B60R 1/22; B60R 2300/10; H04N 5/23229

(57) ABSTRACT

Techniques are disclosed relating to an improved computer vision system for operators of enclosed vehicles. In various embodiments, a computer system receives a first group of video feeds from a first group of one or more cameras located on an exterior of a vehicle. The computer system creates from the first group of video feeds, a combined video feed for a user that depicts a unified view of an external environment of the vehicle from a point of view that is based on position information and orientation information for the user. The computer system further creates a modified video feed by overlaying the combined video feed with non-obscuring reference markers that indicate a position of one or more reference points in the interior portion of the vehicle. The computer system provides the modified video feed to a display device for display in the user's field of vision.

### RELATED APPLICATION

The present application claims priority to U.S. Prov. Appl. No. 63/087,609, filed Oct. 5, 2020, which is incorporated by reference herein in its entirety.

### BACKGROUND

### Technical Field

This disclosure relates generally to a video display for a vehicle that overlays indicia of interior structures of the vehicle with an exterior view.

### Description of the Related Art

In some vehicles, the user's view of the external environment is often limited due to the enclosed nature of the vehicle. Often the limitations in the user's view are due to interior structures of the vehicle. Some vehicles may be designed in a manner so as to emphasize the safety of the users or occupants of the vehicle at the expense of the visibility of the external environment from inside the vehicle.

### BRIEF DESCRIPTION OF THE DRAWINGS

FIG. 1 is a block diagram illustrating example elements of a system for providing a video display to a user of a vehicle.

FIG. 2 is a block diagram illustrating an exemplary module of an embodiment of a computer system that implements adjustments to a particular external video feed based on user input.

FIG. 3 depicts an example view of an external environment.

FIG. 4 shows an example of a limited exterior view of the environment of FIG. 3, from the interior of a vehicle.

FIG. 5 illustrates an overlay of the exterior view of the environment with non-obscuring reference markers that indicate a position of one or more reference points in the interior portion of the vehicle.

FIG. 6 shows a flowchart of an example method implemented by a computer system to implement a video display for a vehicle.

FIG. 7 is a block diagram of one embodiment of a computer system for implementing various systems described in the present disclosure.

### DETAILED DESCRIPTION

For operators of certain types of vehicles, exterior visibility due to interior obstructions can be quite limited. This is particularly the case for military vehicles such as tanks, in which safety of occupants of the vehicle is of paramount importance. In such vehicles, visibility is often limited and may be provided through periscopes, one or more small windows. This lack of visibility can, in some cases, impair operation of the vehicle—for example, by making it less natural to operate for the operator.

The present disclosure recognizes that improved vehicle operation may be facilitated by a display that provides an unobstructed view of the external environment, while still allowing the operator to maintain his or her frame of reference within the vehicle. This may be accomplished by combining video feeds from or more external cameras to create a unified view of the environment. A modified video feed may then be created based on the user's (operator's) current position and orientation within the vehicle by selecting a portion of the combined video feed to present to the user. This modified video feed may also include indicia of the interior structure of the vehicle to provide a frame of reference. For example, portions of the interior structure of the vehicle can be indicated in outline. This user interface paradigm can advantageously provide maximum user visibility while minimizing the chance that the user becomes disoriented while operating the vehicle.

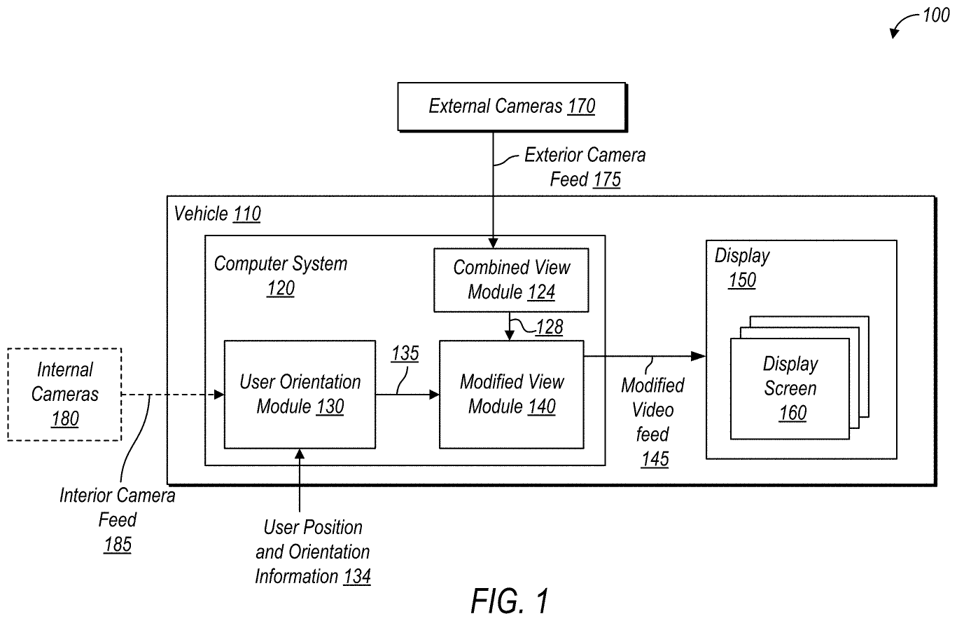

Turning now to FIG. 1, a block diagram is shown of a system 100 for implementing a user interface for a vehicle with video overlay capabilities. In the illustrated embodiment, system 100 includes a vehicle 110, computer system 120, a display 150 with one or more associated display screens 160, external cameras 170, and internal cameras 180. In some embodiments, system 100 may be implemented differently than illustrated. For example, internal cameras 180 may not be present in certain embodiments.

Vehicle 110, in some embodiments, is configured to transport people and various forms of cargo. In a military setting, vehicle 110 may be largely enclosed to protect a user (and other occupants) of vehicle 110 from external threats. As noted, vehicle 110 may be a tank or other battlefield vehicle in some embodiments, while in other embodiments, it may be an aerial vehicle.

Vehicle 110 may have one or more external cameras 170. Cameras 170 are a set of one or more optical instruments that are configured to capture images (or video feeds) of an external environment of vehicle 110. In many cases, one or more external cameras 170 may be oriented in different directions relative to one another in order to facilitate capturing views of the external environment from multiple vantage points. External cameras 170 interface with computer system 120 via exterior camera feed 175.

Internal cameras 180, in various embodiments, are a set of one or more optical instruments that are configured to capture images (or video feeds) of an internal environment of vehicle 110. In some embodiments, one or more internal cameras 180 may be oriented in different directions to facilitate capturing views of the interior environment of vehicle 110 from multiple different vantage points. Internal cameras 180 interface with computer system 120 via interior camera feed 185. As noted, in some embodiments, internal cameras 180 and interior camera feed 185 are optional. In such embodiments, computer system 120 may have access to information representative of the interior of vehicle 110, particularly in situations where there may be not a lot of flexibility for a user of vehicle 110 to be located in multiple positions inside vehicle 110. For example, computer system 120 may have access to a three-dimensional map of the interior of vehicle 110, which is can be a substitute for feed 185. In short, computer system 120 may have access to information that is indicative of the interior of vehicle 110, whether via feed 185 or other means.

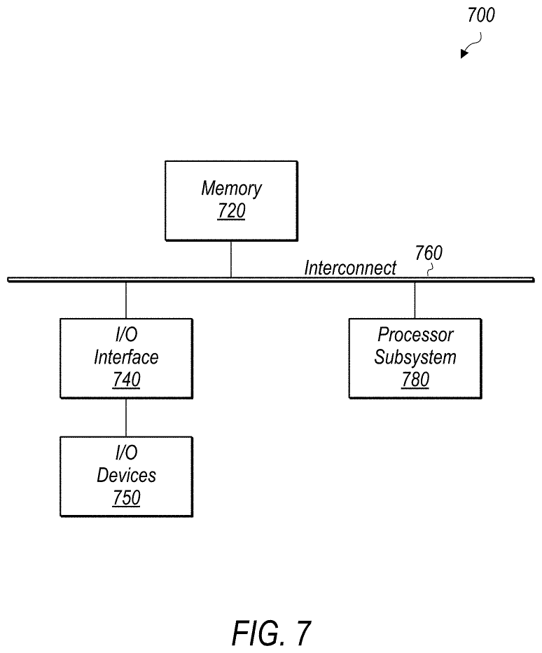

One example of computer system 120 is described below with reference to FIG. 7. Continuing with the description of FIG. 1, as depicted, computer system 120 may receive inputs from cameras 170 and 180, and interact with a display 150 that is associated with one or more display screens 160. Computer system 120 may include software stored in computer memory that executes on one or more processors to provide a user interface (modified video feed 145) to the vehicle operator via the one or more display screens 160 of display 150. This user interface may be generated in one embodiment by modified view module 140 based on combined video feed 128 received from combined view module 124 and non-obscuring reference markers 135 received from user orientation module 130.

As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. Accordingly, a module that is described as being “executable” to perform operations refers to a software module, while a module that is described as being “configured” to perform operations refers to a hardware module. A module that is described as “operable” to perform operations refers to a software module, a hardware module, or some combination thereof. Further, for any discussion herein that refers to a module that is “executable” to perform certain operations, it is to be understood that those operations may be implemented, in other embodiments, by a hardware module “configured” to perform the operations, and vice versa.

Combined view module 124 is executable to receive exterior camera feed from multiple external cameras 170 in order to create a “stitched together view” to provide as much visibility to the user as possible. Combined video feed 128 may be generated in some embodiments by performing image analysis to determine overlapping portions of images from cameras covering adjacent portions of the field of view, and then eliminating these redundant portions of the video feed to store a unified view in a memory of computer system 120. Accordingly, combined video feed 128 may include, in many instances, more information than is currently required based on the user's position and orientation.

Additionally, information about the interior of the vehicle may optionally be received via interior camera feed 185 from internal cameras 180. User orientation module 130 may then receive information indicating the operator's current location and orientation to generate “non-obscuring reference markers” 135 that can be overlaid on the combined video feed to generate a modified video feed that can be presented to the user via display screen 160. In some embodiments, user orientation module 130 determines the operator's current location and orientation using visual inertial odometry (VIO), a technique in which the interior camera feed 185 may be analyzed along with the input of an inertial measurement unit (IMU). For example, in an embodiment in which display 150 is a head-mounted display, one or more cameras 180 (along with an IMU) may be included in the head-mounted display and arranged to capture the operator's field of view. As the operator's head turns left or right (and/or moves forward or backward or up or down), module 130 may detect a change in the camera feed and corresponding change in information 134 provided by the IMU. Based on this detection, module 130 may use VIO to determine a corresponding change in the orientation (and/or position) of the operator's head. In another example, cameras 180 and an IMU may be included in a moving portion of the vehicle such as a rotating tank turret. As the operator changes the orientation of this portion, module 130 may use VIO to determine the orientation.

User orientation module 130 is executable to facilitate the generation of non-obscuring reference markers 135 to be included in modified video feed 145. Non-obscuring reference markers 135 indicate a position of one or more reference points in the interior portion of the vehicle. Reference markers 135 may take the form of a see-through outline of interior portions of the vehicle in some embodiments. In some embodiments, user orientation module 130 provides an interface to receive interior camera feed 185 from internal cameras 180 to determine how non-obscuring reference markers 135 should be drawn, given the position and orientation information 134 of the user. In some other embodiments, user orientation module 130 may utilize stock pictures (or static information) about the interior of vehicle 110 stored in a memory of computer system 120 as a substitute for interior camera feed 185. In such embodiments, internal cameras 180 would be optional. As used herein, position information indicates the user's location in the interior portion of the vehicle, while orientation information indicates where the user is looking (e.g., how the user's head is positioned). In either case, position and orientation information 134 is used to select a currently visible portion of the interior of vehicle 110, using either feed 185 or predetermined information about an interior of vehicle 110. Although FIG. 1 depicts position and orientation information 134 as being received by user orientation module 130, in some embodiments, position and orientation information 134 may also be used by modified view module 140 to, for example, crop combined video feed 128 to an operator's current field of view.

In some cases, the orientation information may be based on information other than the user's current direction of view. For example, user input may indicate a desired field of vision that is outside the user's “natural” field of vision. For example, the user might provide input (e.g., through a steering mechanism or joystick) that directs the user interface to display a view directly behind where the user is currently looking. In another example, a user might turn his or her head as far as possible in one direction, and then use a user control to continue to change the field of view (e.g., in the direction of the head turn).

Display 150, in various embodiments, is an output device for presenting information in visual form. For example, display 150 covers the user's field of vision and presents the modified video feed 145 to a user who is operating vehicle 110. Display 150 may be implemented by various different technologies, with Electroluminescent (ELD) display, Liquid crystal display (LCD), Light-emitting diode (LED) backlit LCD, Thin-film transistor (TFT) LCD, Light-emitting diode (LED) display, organic light-emitting diode (OLED) display, active-matrix organic light-emitting diode (AMOLED) display, Plasma (PDP) display, Quantum dot (QLED) display, etc., being non-limiting examples of display 150.

In various embodiments, display 150 may include one or more display screens 160 that are actual embodiments of a display 150 implemented through one or more display technologies alluded to earlier. In some embodiment, the modified video feed 145 may be fed by display 150 to one or more display screens 160, with one or more display screens 160 being implemented as part of a head-mounted device (HMD), or as a cockpit inside vehicle 110. The connection between display 150 and display screen 160 may be wired or wireless, and display screen 160 may be reachable by display 150 through a wide-area network in some embodiments.

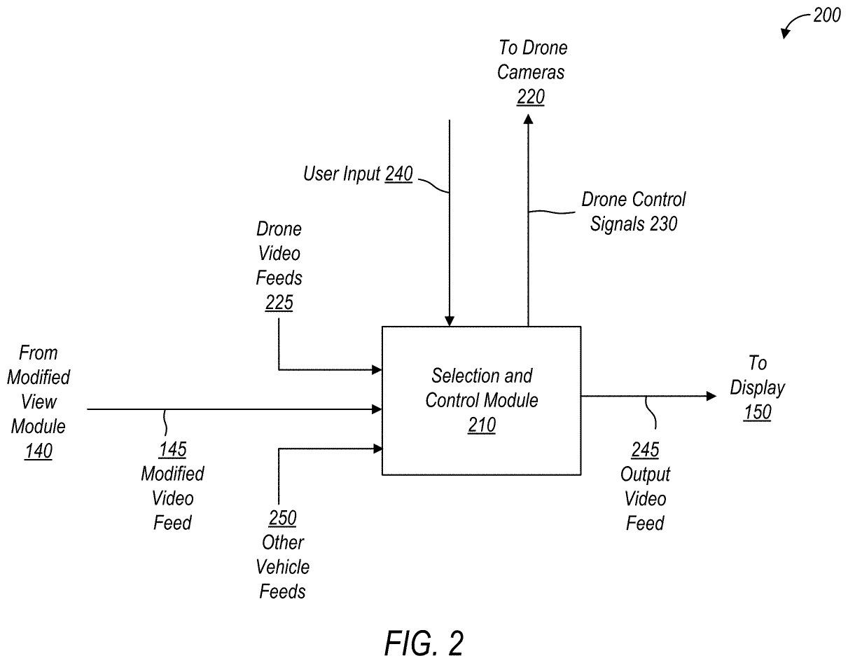

The techniques illustrated in FIG. 1 thus allow computer system 120 to generate a combined external view of the vehicle's environment overlaid with non-obscuring reference markers that correspond to structures in the interior of the vehicle. This user interface affords operators of certain types of vehicle a greatly expanded field of view, while still providing a frame of reference within the vehicle. The present disclosure also contemplates that the user interface can provide views from other sources, as described next with reference to FIG. 2.

Turning now to FIG. 2, a block diagram 200 of a selection and control module 210 is shown. In FIG. 1, modified video feed 145 is provided to display 150. FIG. 2 contemplates embodiments in which module 210 is interposed between module 140 and display 150. In such embodiments, module 210 receives other possible video sources in addition to feed 145.

For example, module 210 may receive video feeds 250 from other vehicles, such as other military vehicles operating in conjunction with vehicle 110. Similarly, module 210 may receive one or more video feeds from drone cameras 220 via drone video feeds 225. The user of vehicle 110 may select between feeds 145, 225, and 250 based on user input 240, thus providing output video feed 245 to display 150. User input 240 may also be used to provide drone control signals 230 to drone cameras 220.

User input 240 may also, in some embodiments, indicate various filtering operations to be applied to output video feed 245. For example, user input 240 may indicate a command to obscure a portion of the modified video feed received from a particular external camera. One example of such a command would be to reduce glare from a particular external camera. Another possible command would filter the image in low-light conditions (e.g., to improve contrast between certain portions of the image).

Any number of additional video processing techniques may also be performed by module 210. For example, module 210 may include one or more graphical objects indicating a preferred route for vehicle 110. Module 210 may also receive information (including from other nearby vehicles) that indicate potential obstructions in the route of vehicle 110. Output video feed may highlight these obstructions in feed 245, indicate a route to avoid these obstructions, or both.

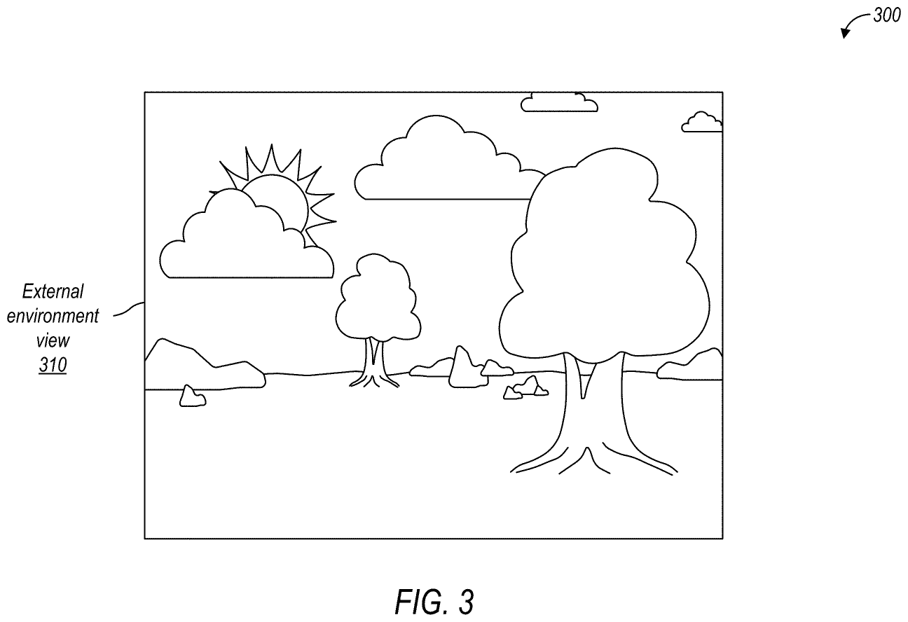

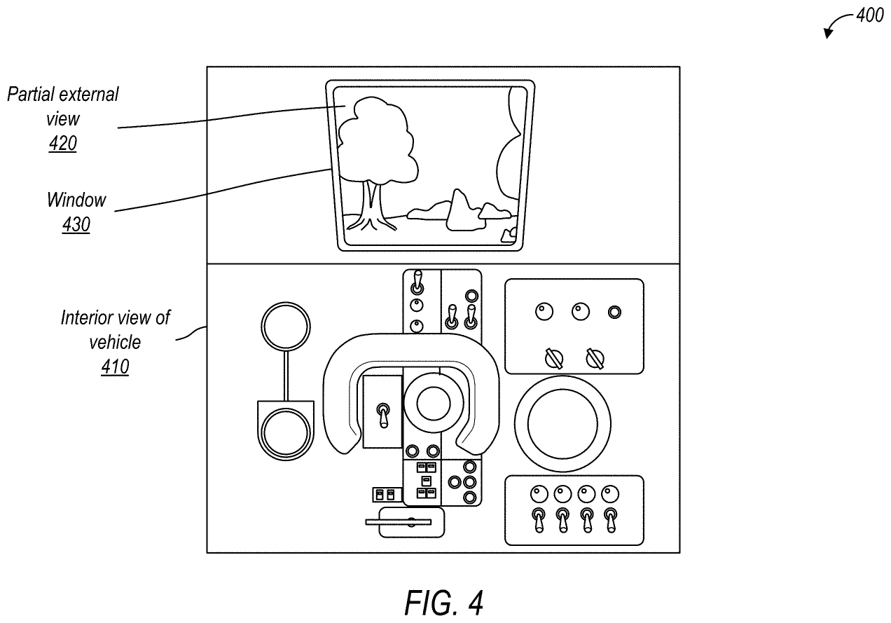

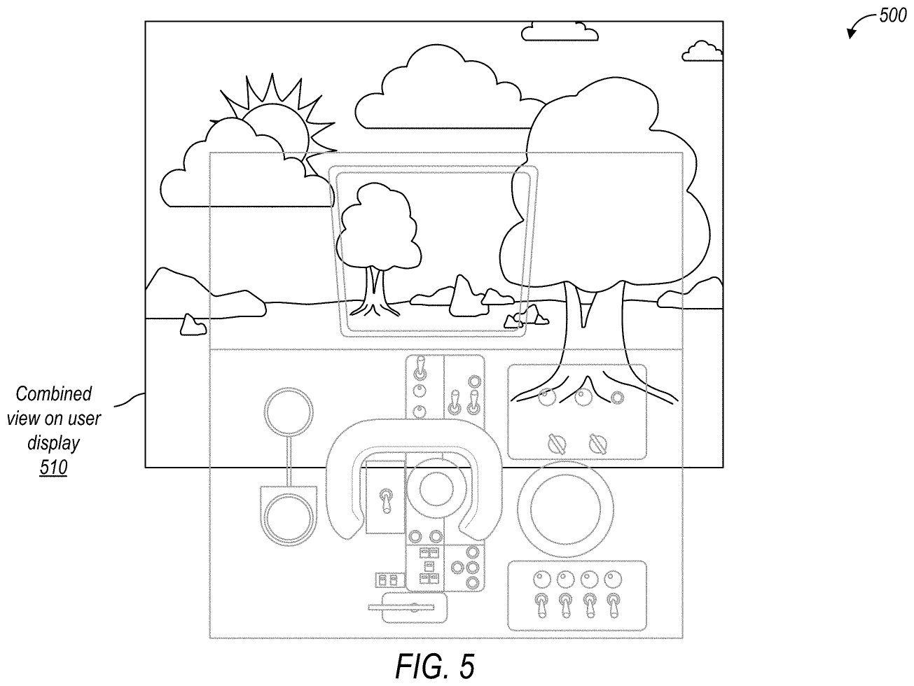

Turning now to FIGS. 3-5, various views are depicted which illustrate one example of the disclosed embodiments. View 310 in FIG. 3 shows a view of an external environment from a particular user location and orientation. This view would, of course, change if the user were to stay in the position but have a different orientation (e.g., by turning around). View 400 in FIG. 4 shows the same view, but in which the user is inside vehicle 110 at the same location and has the same orientation. As can be seen, with certain types of vehicles 110, the view of the user's external environment (shown as through window 430) can be severely circumscribed and thus lead to reduced situational awareness (the user can only see partial view 420 via window 430). Also depicted in FIG. 4 is an interior view 410 of the vehicle as seen by the operator. Example 500, however, illustrates a combined view 510 of the external environment overlaid with non-obscuring references markers that correspond to reference points of the interior of the vehicle. Here, the non-obscuring references markers correspond to a semi-transparent hologram of the interior of the vehicle as shown from the current position of the user inside the vehicle. View 510 illustrates the advantage of increased visibility to the user of the external environment, since the overlaid view presents a fuller view of the external environment relative to the partial external view that would otherwise be available through window 430. View 510 thus affords increased visibility to the user of vehicle 110 while minimizing disorientation to the user by including non-obscuring reference makers.

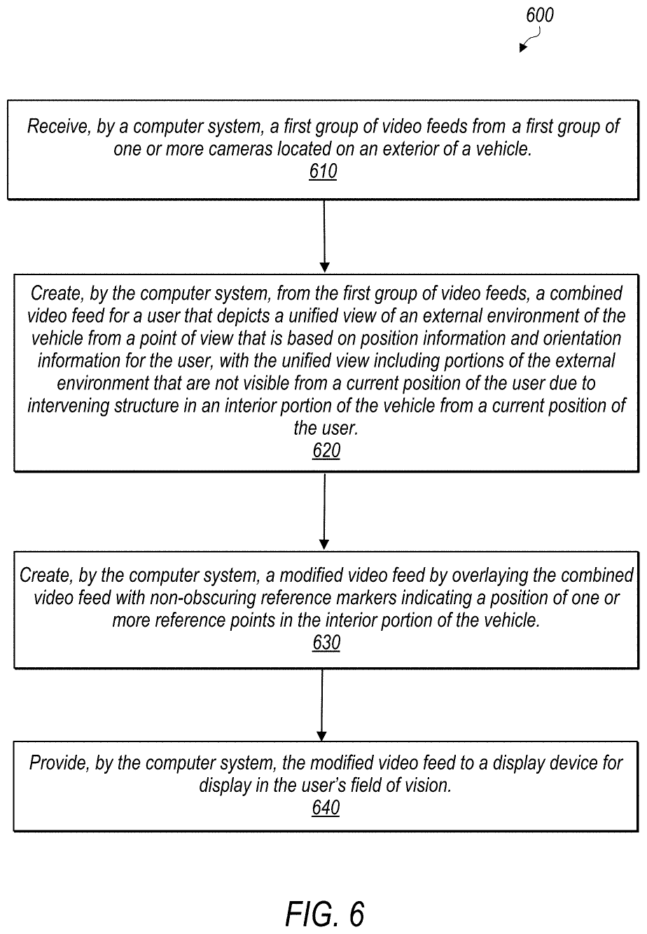

Turning now to FIG. 6, a flowchart of an example method 600 implemented by a computer system is shown. In the illustrated embodiment, at step 610, the computer system (e.g., computer system 120) receives a first group of video feeds (or example, exterior camera feed 175) from a first group of one or more cameras (for example, external cameras 170) located on an exterior of a vehicle.

At step 620, the computer system creates, from the first group of video feeds, a combined video feed for a user that depicts a unified view of an external environment of the vehicle from a point of view that is based on position information and orientation information for the user, with the unified view including portions of the external environment that are not visible from a current position of the user due to intervening structure in an interior portion of the vehicle from a current position of the user. In various embodiments, the combined video feed represents the feed from one or more external cameras that are stitched together, and corresponds to where the user is looking based on the position information and orientation information of the user. Step 620 provides an important limitation that allows the user's field of vision to equate to what the user would see if the interior structure of the vehicle itself was not there.

At step 630, the computer system creates a modified video feed by overlaying the combined video feed with non-obscuring reference markers indicating a position of one or more reference points in the interior portion of the vehicle. For example, this step provides that the structure of the interior of the vehicle that the user would ordinarily see would be indicated in a see-through outline (for example, a semi-transparent hologram of the interior structure of the vehicle). This allows greater visibility of the external environment for the user but still allows the user to maintain the user's frame of reference within the vehicle, and thus prevents the user from getting disoriented while operating the vehicle.

At step 640, the computer system provides the modified video feed to a display device for display in the user's field of vision. In various embodiments, the display device covers the user's field of vision and presents the modified video feed to the user.

### Exemplary Computer System

Turning now to FIG. 7, a block diagram of an exemplary computer system 700 is depicted. Computer system 700 may be representative of any of computer systems described in this disclosure, for example, computer system 120. Computer system 700 includes a processor subsystem 780 that is coupled to a system memory 720 and I/O interfaces(s) 740 via an interconnect 760 (e.g., a system bus). I/O interface(s) 740 is coupled to one or more I/O devices 750. Computer system 700 may include additional functionality other than what is indicated in FIG. 7.

Processor subsystem 780 may include one or more processors or processing units. In various embodiments of computer system 700, multiple instances of processor subsystem 780 may be coupled to interconnect 760. In various embodiments, processor subsystem 780 (or each processor unit within 780) may contain a cache or other form of on-board memory.

System memory 720 is usable store program instructions executable by processor subsystem 780 to cause system 700 perform various operations described herein. System memory 720 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as memory 720. Rather, computer system 700 may also include other forms of storage such as cache memory in processor subsystem 780 and secondary storage on I/O Devices 750 (e.g., a hard drive, storage array, etc.). In some embodiments, these other forms of storage may also store program instructions executable by processor subsystem 780. In some embodiments, program instructions that when executed implement a computer system 120 may be included/stored within system memory 720.

I/O interfaces 740 may be any of various types of interfaces configured to couple to and communicate with other devices, according to various embodiments. In one embodiment, I/O interface 740 is a bridge chip (e.g., Southbridge) from a front-side to one or more back-side buses. I/O interfaces 740 may be coupled to one or more I/O devices 750 via one or more corresponding buses or other interfaces. Examples of I/O devices 750 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device 750 (e.g., configured to communicate over WiFi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

Unless stated otherwise, the specific embodiments are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

Particular features, structures, or characteristics may be combined in any suitable manner consistent with this disclosure. The disclosure is thus intended to include any feature or combination of features disclosed herein (either explicitly or implicitly), or any generalization thereof. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

Where appropriate, it is also contemplated that claims drafted in one statutory type (e.g., apparatus) suggest corresponding claims of another statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to the singular forms such “a,” “an,” and “the” are intended to mean “one or more” unless the context clearly dictates otherwise. Reference to “an item” in a claim thus does not preclude additional instances of the item.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” covering x but not y, y but not x, and both x and y. On the hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one of element of the set [w, x, y, z], thereby covering all possible combinations in this list of options. This phrase is not to be interpreted to require that there is at least one instance of w, at least one instance of x, at least one instance of y, and at least one instance of z.

Various “labels” may proceed nouns in this disclosure. Unless context provides otherwise, different labels used for a feature (e.g., “first circuit,” “second circuit,” “particular circuit,” “given circuit,” etc.) refer to different instances of the feature. The labels “first,” “second,” and “third” when applied to a particular feature do not imply any type of ordering (e.g., spatial, temporal, logical, etc.), unless stated otherwise.

Within this disclosure, different entities (which may variously be referred to as “units,” “circuits,” other components, etc.) may be described or claimed as “configured” to perform one or more tasks or operations. This formulation—[entity] configured to [perform one or more tasks]— is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function. This unprogrammed FPGA may be “configurable to” perform that function, however.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

In this disclosure, various “modules” operable to perform designated functions are shown in the figures and described in detail above (e.g., user orientation module 130, modified view module 140, selection and control module 210, etc.).

What is claimed is:

1. A method, comprising:
receiving, by a computer system, a first group of video feeds from a first group of one or more cameras located on an exterior of a vehicle;
creating, by the computer system, from the first group of video feeds, a combined video feed for a user that depicts a unified view of an external environment of the vehicle from a point of view that is based on position information and orientation information for the user, wherein the unified view includes portions of the external environment that are not visible from a current position of the user due to intervening structure in an interior portion of the vehicle;
creating, by the computer system, a modified video feed by overlaying the combined video feed with non-obscuring reference markers that indicate a position of one or more reference points in the interior portion of the vehicle; and
providing, by the computer system, the modified video feed to a display device for display in the user's field of vision.

2. The method of claim 1, further comprising:
receiving, by the computer system, a second group of video feeds from a second group of one or more cameras located within the interior portion of the vehicle; and
wherein creating the modified video feed includes using information from the second group of video feeds to overlay the non-obscuring reference markers.

3. The method of claim 1, wherein creating the modified video feed includes using static information about the interior portion of the vehicle to overlay the non-obscuring reference markers.

4. The method of claim 1, wherein the non-obscuring reference markers include a semi-transparent hologram of the structure of the interior of the vehicle that is overlaid on the combined video feed.

5. The method of claim 1, wherein the display device is a head-mounted display worn by a user of the device.

6. The method of claim 5, wherein the position information indicates the user's location in the interior portion of the vehicle, and wherein the orientation information indicates how the user's head is positioned.

7. The method of claim 5, wherein the position information indicates the user's location in the interior portion of the vehicle, and wherein the orientation information is based on user input indicated a desired field of vision.

8. The method of claim 1, further comprising receiving, by the computer system, user input to obscure a portion of the modified video feed.

9. The method of claim 1, further comprising receiving, by the computer system, user input to reduce glare.

10. The method of claim 1, further comprising receiving, by the computer system, user input to activate low-light operation.

11. The method of claim 1, further comprising receiving, by the computer system, user input to adjust contrast between portions of a displayed image.

12. The method of claim 1, further comprising receiving, by the computer system, user input to switch to a view from a source other than vehicle.

13. The method of claim 12, wherein the source is a land-based vehicle.

14. The method of claim 12, wherein the source is a drone.

15. The method of claim 1, further comprising:
applying, by the computer system, image processing techniques on a portion of the first group of video feeds received from another vehicle to determine obstructions in a planned route of the vehicle; and
in response to determining obstructions in the planned route, causing display, by the computer system, of a modified route to the user.

16. A non-transitory, computer-readable storage medium storing program instructions executable on a computer system of a vehicle to perform operations comprising:
receiving a first group of video feeds from a first group of one or more cameras located on an exterior of the vehicle;
creating, from the first group of video feeds, a combined video feed for a user that depicts a unified view of an external environment of the vehicle from a point of view that is based on position information and orientation information for the user, wherein the unified view includes portions of the external environment that are not visible from a current position of the user due to intervening structure in an interior portion of the vehicle;
creating a modified video feed by overlaying the combined video feed with non-obscuring reference markers that indicate a position of one or more reference points in the interior portion of the vehicle; and
providing the modified video feed to a display device for display in the user's field of vision.

17. A vehicle, comprising:
one or more sensors on an exterior of the vehicle;
a display device;
a computer system having a memory a processor circuit, the memory storing program instructions executable by the processor circuit to perform operations comprising:
receiving a first group of video feeds from a first group of one or more cameras located on an exterior of the vehicle;
creating, from the first group of video feeds, a combined video feed for a user that depicts a unified view of an external environment of the vehicle from a point of view that is based on position information and orientation information for the user, wherein the unified view includes portions of the external environment that are not visible from a current position of the user due to intervening structure in an interior portion of the vehicle;
creating a modified video feed by overlaying the combined video feed with non-obscuring reference markers that indicate a position of one or more reference points in the interior portion of the vehicle; and
providing the modified video feed to a display device for display in the user's field of vision.

18. The vehicle of claim 17, wherein the vehicle is a tank.

19. The vehicle of claim 17, wherein the vehicle is an aerial vehicle.

20. The vehicle of claim 17, wherein the display device is a head-mounted display device.
